(19) United States
(12) Patent Application Publication
(10) Pub. No.: US 2009/0115972 A1
(43) Pub. Date: May 7, 2009

(54) Projection Apparatus and Cabinet Thereof

(75) Inventors: Jyunichi Aizawa, Tokyo (JP); Akihisa Miyata, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 11/988,562

(22) PCT Filed: Sep. 12, 2006
(86) PCT No.: PCT/JP2006/318050

§ 371 Date: Jan. 10, 2008

(30) Foreign Application Priority Data
Sep. 21, 2005 (JP) 2005-273686

(51) Int. Cl. G03B 21/10

(52) U.S. Cl. 353/74; 353/119

(57) ABSTRACT

A cabinet is provided in a projection apparatus including a rectangular screen (200), and an optical engine (300) that projects an image onto a back surface of the screen (200) from a lower side thereof. The cabinet includes a screen frame (100) that holds four sides of the screen (200) and has at least an upper-side frame (1) that supports an upper side of the screen (200), a bottom plate (9) that holds the optical engine (300) and has an end portion mounted to the screen frame (100), and a reinforcing stay (10b) that connects the upper-side frame (1) of the screen frame (100) and the other end portion of the bottom plate (9) along a contour of light ray (18a) projected onto the screen (200).

### TECHNICAL FIELD

This invention relates to a projection apparatus such as a rear projector or the like that projects an image onto a screen from a back side thereof, and a cabinet of the projection apparatus.

### BACKGROUND ART

In a general rear projector, optical components (such as a screen, a rear mirror, an optical engine or the like) are mounted in a cabinet formed of panels assembled in the form of a box. However, the assembling accuracy of the cabinet and the positioning accuracies of respective optical components with respect to the cabinet are not high, and therefore it is difficult to keep the positional relationship among the respective optical components with respect to one another. Therefore, it is difficult to sufficiently ensure optical performances of the respective optical components, and there is a problem that distortion or displacement of an image projected on the screen occurs, or a part of the image on the screen is blurred out of focus.

Therefore, there is proposed a rear projector so configured that a sheet-metal frame is mounted onto a wooden bottom cabinet, and the sheet-metal frame is covered with a back cover. An optical engine is mounted to the bottom cabinet. A screen and a rear mirror are mounted to the sheet-metal frame (see, for example, Patent Document No. 1). Further, there is proposed another rear projector in which a screen-mounting portion and a mirror-mounting portion both made of plastic are used instead of the sheet-metal frame (see, for example, Patent Document No. 2).

Patent Document No. 1: Japanese Laid-Open Patent Publication No. 5-183847 (Paragraphs 0009-0011, FIG. 1).

Patent Document No. 2: Japanese Laid-Open Patent Publication No. 9-9185 (Paragraphs 0007, FIG. 1).

### DISCLOSURE OF THE INVENTION

### Problems to be Solved by the Invention

Here, in a rear projector equipped with a very wide angle optical engine, the light emitted by the optical engine is incident on the screen at a large incident angle. In such a rear projector, the position of the image on the screen largely changes even when the screen is slightly inclined. In a configuration in which the optical engine is mounted to the bottom cabinet, and the screen or the like is mounted to the sheet-metal frame or like as described above (Patent Documents No. 1 and 2), it is difficult to correctly determine the angle of the screen with respect to the optical engine.

Further, the above described conventional rear projector is supported by the wooden bottom cabinet (Patent Document No. 1), or employs the plastic cabinet (Patent Document No. 2), and therefore it is difficult to ensure a sufficient rigidity. Further, there is a possibility that the inclination of the screen or the like may be caused by the influence of the vibration during transportation or the influence of the installation location, and therefore the distortion or displacement of the image can not be completely prevented.

The present invention is intended to solve the above described problems, and the object of the present invention is to prevent the distortion or displacement of the image, by enhancing the accuracies of mounting positions and mounting angles of the respective optical components, and by restricting the influence of the vibration during transportation and the influence of the installation location.

### Means of Solving the Problems

The present invention provides a cabinet of a projection apparatus including a rectangular screen and an optical engine that projects an image onto a back surface of said screen from below. The cabinet includes a screen frame that holds four sides of the screen, the screen frame having at least an upper-side frame that supports an upper side of the screen, a bottom plate that holds the optical engine, an end portion of the bottom plate being mounted to the screen frame, and a reinforcing stay that connects the upper-side frame of the screen frame and the other end portion of the bottom plate along a contour of light ray projected onto the screen.

### EFFECT OF THE INVENTION

According to the present invention, since the upper-side frame of the screen frame and the bottom plate are connected using the reinforcing stay, the angle between the bottom plate and the screen frame can be correctly determined. With this, the relative angle between the optical engine held by the bottom plate and the screen held by the screen frame can be correctly determined. Further, by employing the structure in which the screen frame, the bottom plate and the reinforcing stay form a triangle as seen from the side, it becomes possible to obtain high rigidity that is hard to deflect even when an external is applied. As a result, it becomes possible to prevent the distortion or displacement of the image on the screen, and to display an excellent image.

### BRIEF DESCRIPTION OF THE DRAWINGS

FIG. 1 is a sectional view showing a rear projector provided with a cabinet according to Embodiment 1 of the present invention.

FIG. 2 is a sectional view showing a light path on the upper part of a screen of the rear projector shown in FIG. 1.

FIG. 3 is a sectional view showing a light path on the lower part of the screen of the rear projector shown in FIG. 1.

FIG. 4 is a perspective view showing the cabinet according to Embodiment 1 of the present invention.

FIG. 5 is a bottom view showing the cabinet according to Embodiment 1 of the present invention.

FIG. 6 is a side view showing a state where a back cover is attached to the cabinet according to Embodiment 1 of the present invention.

FIG. 7 is a side view showing a state where the back cover is detached from the cabinet according to Embodiment 1 of the present invention.

FIG. 8 is a front view showing a state where the screen is mounted to the cabinet according to Embodiment 1 of the present invention.

FIG. 9 is a sectional view showing an upper-side frame of the cabinet according to Embodiment 1 of the present invention.

FIG. 10 is a sectional view showing a side frame of the cabinet according to Embodiment 1 of the present invention.

FIG. 11 is a sectional view showing a bottom frame of the cabinet according to Embodiment 1 of the present invention.

FIG. 12 is a sectional view showing a lower-side frame of the cabinet according to Embodiment 1 of the present invention.

FIG. 13 is a perspective view showing other configuration example of the screen frame of the cabinet according to Embodiment 1 of the present invention.

FIG. 14 is a bottom view showing other configuration example of the screen frame of the cabinet according to Embodiment 1 of the present invention.

FIG. 15 is a perspective view showing a cabinet according to Embodiment 2 of the present invention.

FIGS. 16(A) and 16(B) are a front view and a side view showing the cabinet according to Embodiment 2 of the present invention.

FIG. 17 is a perspective view showing a cabinet according to Embodiment 3 of the present invention.

FIG. 18 is a side view showing the cabinet according to Embodiment 3 of the present invention.

FIG. 19 is a front view showing the cabinet according to Embodiment 3 of the present invention.

FIG. 20 is a sectional view showing an upper-side frame of the cabinet according to Embodiment 3 of the present invention.

FIG. 21 is a sectional view showing a side frame of the cabinet according to Embodiment 3 of the present invention.

FIG. 22 is a sectional view showing a lower-side frame of the cabinet according to Embodiment 3 of the present invention.

FIG. 23 is a perspective view showing the cabinet according to Embodiment 3 of the present invention.

FIG. 24 is a sectional view showing a rear projector provided with a cabinet according to Embodiment 4 of the present invention.

FIG. 25 is a perspective view showing the cabinet shown in FIG. 24.

FIG. 26 is a view showing a part of a rear projector according to a modification of Embodiment 4 in an enlarged scale.

### DESCRIPTION OF REFERENCE MARKS

1 . . . upper-side frame, 2a, 2b . . . side frame, 3 . . . lower-side frame, 6a, 6b . . . corner plate, 8b . . . bottom frame, 9 . . . bottom plate, 10a, 10b . . . reinforcing stay, 11a, 11b . . . reinforcing stay, 14a, 14b . . . insulator, 18a, 18b, 18c . . . light ray, 20 . . . reinforcing plate, 31 . . . upper-side frame, 32a, 32b . . . side frame, 33 . . . lower-side frame, 34a, 34b . . . corner plate, 35 . . . bottom plate, 37a, 37b . . . reinforcing stay, 41a, 41b . . . bracing strut, 50 . . . cabinet base, 60 . . . spring, 100, 101 . . . screen frame, 200 . . . screen, 300 . . . optical engine.

### BEST MODE FOR CARRYING OUT THE INVENTION

### Embodiment 1

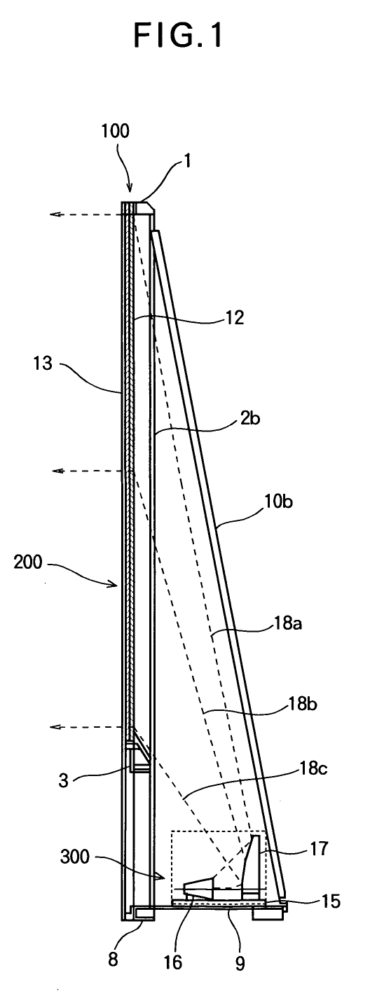

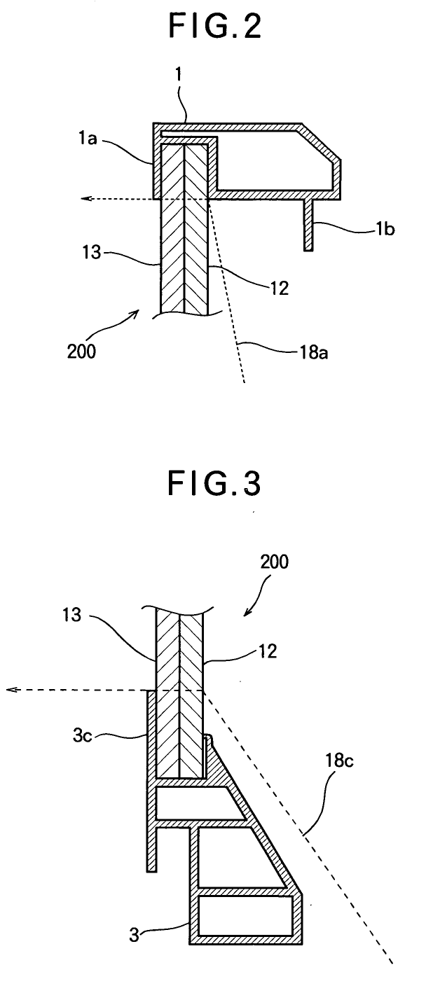

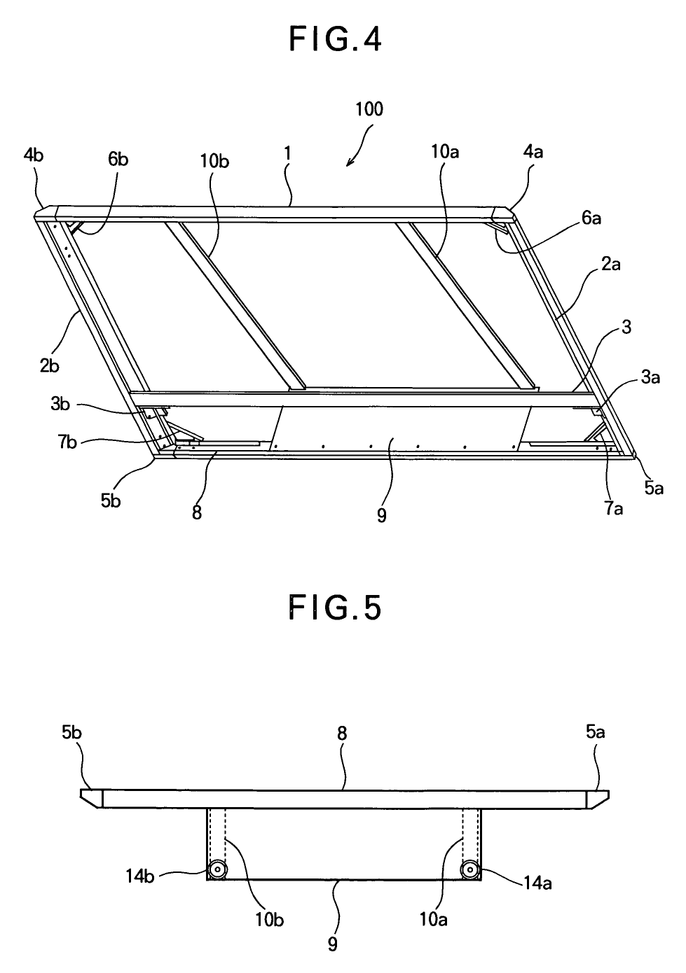

FIG. 1 is a sectional view showing a rear projector (a projection apparatus) provided with a cabinet according to Embodiment 1 of the present invention. FIG. 2 is a sectional view showing a light path on the upper part of a screen of the rear projector shown in FIG. 1. FIG. 3 is a sectional view showing a light path of the lower part of the screen of the rear projector shown in FIG. 1. FIG. 4 is a perspective view showing the cabinet according to Embodiment 1. FIG. 5 is a bottom view showing the cabinet according to Embodiment 1.

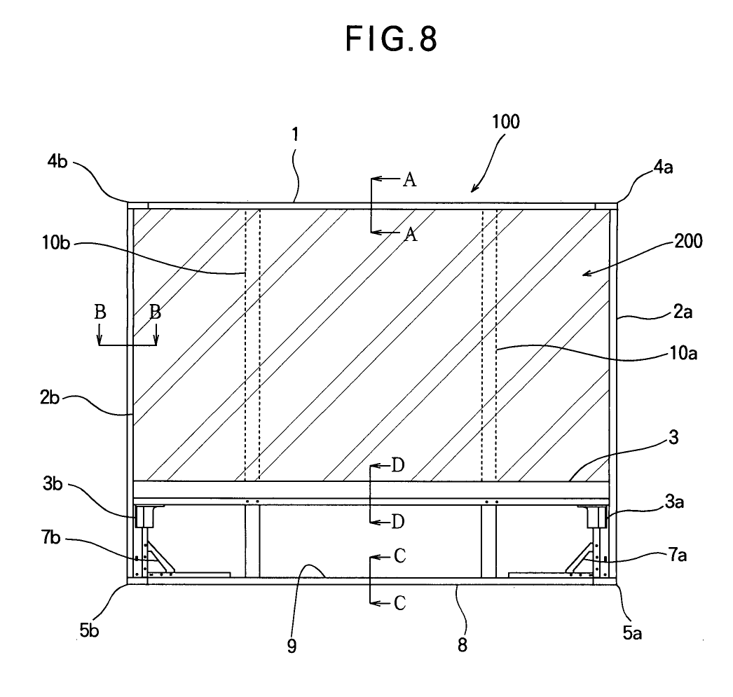

As shown in FIG. 1, the rear projector includes a screen 200 and an optical engine 300 that projects the light onto the back surface of the screen 200 from below. The screen 200 is placed so that the surface thereof is a vertical surface. The screen 200 has a rectangular shape in which upper and lower sides are longer and both lateral sides are shorter (see FIG. 8). Hereinafter, the direction in which the light is emitted from the screen 200 (left in FIG. 1) is referred to as “front”, and the opposite direction (right in FIG. 1) is referred to as “rear”.

The screen 200 is composed of a Fresnel screen 12 and a lenticular screen 13 superimposed on each other. The optical engine 300 includes an engine base 15, a not shown illumination optical system, and a projection optical system (including a projection lens 16 and an aspheric mirror 17). The light emitted by the illumination optical system is enlarged by the projection lens 16 and the aspheric mirror 17, reflected by the aspheric mirror 17, and incident on the screen 200 from a lower side thereof.

Light rays 18a through 18c reflected by the aspheric mirror 17 change their travelling directions due to the Fresnel screen 12, and are emitted frontward through the lenticular lens 13. As shown in FIG. 2, the light ray 18a incident on the upper part of the screen 200 is deflected by the Fresnel screen 12, and emitted horizontally through the lenticular screen 13. The upper end of an image plane (upper limit of an area through which the light is emitted) is regulated by an end surface 1a of an upper-side frame 1. As shown in FIG. 3, the light ray 18c incident on the lower part of the screen 200 is deflected by the Fresnel screen 12, and emitted horizontally through the lenticular screen 13. The lower end of the image plane (lower limit of the area through which the light is emitted) is regulated by an end surface 3c of a lower-side frame 3.

As shown in FIG. 4, the cabinet according to this embodiment includes a screen frame 100 that holds the screen 200 (FIG. 1), and a bottom plate 9 that holds the optical engine 300 (FIG. 1). The screen frame 100 includes the upper-side frame 1 and the lower-side frame 3 that are parallel to each other and respectively support an upper side and a lower side of the screen 200 (FIG. 1), and side frames 2a and 2b that respectively support both lateral sides of the screen 200. The side frames 2a and 2b extend downwardly beyond the lower-side frame 3. A bottom frame 8 is so provided as to connect the lower ends of the side frames 2a and 2b, and is parallel to the lower-side frame 3.

In the screen frame 100, the upper-side frame 1 and the side frames 2a and 2b are connected by corner joints 4a and 4b. Similarly, the side frames 2a and 2b and the bottom frame 8 are lined by the corner joints 5a and 5b. The upper-side frame 1, the side frames 2a and 2b and the bottom frame 8 constitute a rectangular frame body. Further, the lower-side frame 3 that supports the lower end portion of the screen 200 (FIG. 1) are mounted to the side frames 2a and 2b via brackets 3a and 3b.

In order to accomplish a light-weight and strong structure, the screen frame 100 is formed of, for example, aluminum extruded material. The corner portion between the upper-side frame 1 and the side frames 2a and 2b are reinforced by corner plates (reinforcing members) 6a and 6b. The corner portion between the side frames 2a and 2b and the bottom frame 8 are reinforced by corner plates (reinforcing members) 7a and 7b. The screen frame 100 has a strong structure which is hard to be deformed, and therefore the flatness of the screen 200 is ensured.

The screen frame 100 does not only function as a holding frame that holds the screen 200, but also functions as a structural member of the cabinet by extending downwardly beyond the screen 200 and being connected with the bottom frame 8 so as to ensure the rigidity of the cabinet. Since the screen frame is commonly used as the structural member, the number of parts can be reduced, and the reduction in weight and cost is accomplished.

The bottom plate 9 that holds the optical engine 300 is composed of a rectangular plate, and the front end portion of the bottom plate 9 is fixed to the bottom frame 8 of the screen frame 100 by means of screws. The bottom plate 9 is placed so that the plate surface is oriented horizontally. The angle between the bottom plate 9 and the screen frame 100 (i.e., the angle between the bottom plate 9 and the screen 200) is a right angle. The width of the bottom plate 9 (the length in the longitudinal direction of the screen 200) is shorter than the width of the screen frame 100.

The cabinet further includes reinforcing stays 10a and 10b that connect the upper-side frame 1 of the screen frame 100 and the rear end portion of the bottom plate 9. By connecting the screen frame 100 and the bottom plate 9 perpendicular to the screen frame 100 using the reinforcing stays 10a and 10b extending obliquely with respect to the screen frame 100 and the bottom plate 9, a rectangular triangle whose base is the bottom plate 9 is formed as seen from the side. With such a structure, the screen frame 100 and the bottom plate 9 are kept at a right angle, and the rigidity of the entire cabinet is enhanced. Further, by the provision of the reinforcing stays 10a and 10b along the outermost light ray 18a as seen from the side (FIG. 1), the position where the reinforcing stays 10a and 10b are fixed to the bottom plate 9 can be situated frontward (toward the screen 200 side), and therefore the depth of the entire cabinet can be reduced.

The reinforcing stays 10a and 10b are formed of, for example, a sheet-metal. Although it is also possible to provide only one reinforcing stay, the effect in enhancing the rigidity of the entire cabinet increases when two (or more) reinforcing stays 10a and 10b are provided. The angle between the screen frame 100 and the bottom plate 9 is determined by the lengths of the reinforcing stays 10a and 10b, and therefore the lengths of the reinforcing stays 10a and 10b are correctly controlled. For enabling the adjustment of the angle of the screen frame 100, it is also possible to make adjustable the lengths of the reinforcing stays 10a and 10b, or to make adjustable the positions of the reinforcing stays 10a and 10b.

As shown in FIG. 5, insulators 14a and 14b are mounted to the bottom of the bottom plate 9 that constitutes the bottom of the cabinet, and the insulators 14a and 14b constitute legs of the cabinet. The insulators 14a and 14b are disposed below the positions where the reinforcing stays 10a and 10b are mounted to the bottom plate 9. By disposing the insulators 14a and 14b below the mounting positions of the reinforcing stays 10a and 10b, the loads applied to the reinforcing stays 10a and 10b are entirely applied to the insulators 14a and 14b. Therefore, it is possible to prevent the bottom plate 9 from being deformed by the loads. In this regard, in the case where the insulators 14a and 14b are disposed at the center portions of the bottom plate 9, there is a possibility that the rear end side of the bottom plate 9 may be deformed downwardly in the case where, for example, the cabinet is distorted and a downward force is applied to the reinforcing stays 10a and 10b. In such a case, there is a possibility that the function of the reinforcing stays 10a and 10b may decrease, and the deformation of the screen frame 100 may occur (with the result that the distortion of the image occurs).

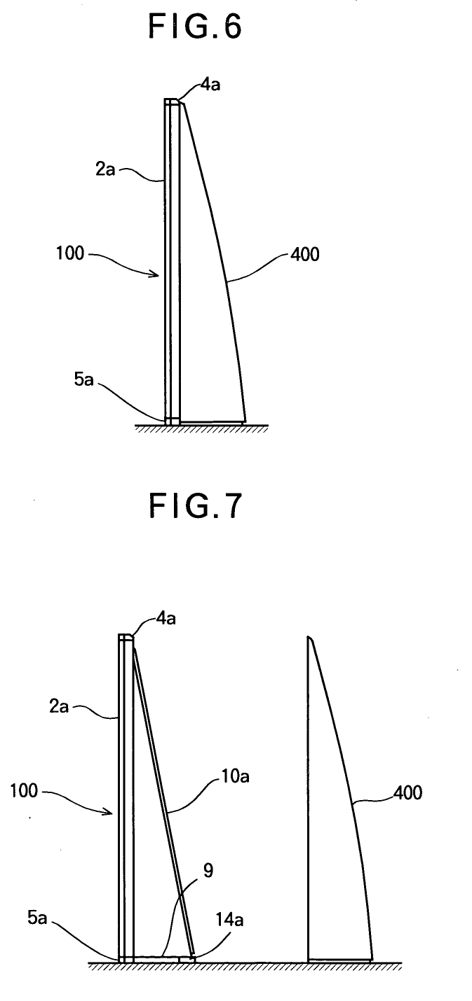

FIG. 6 is a side view showing a state where a back cover 400 is attached to the cabinet according to this embodiment. FIG. 7 is a side view showing a state where the back cover 400 is detached from the cabinet according to this embodiment. The cabinet of this embodiment has a frame structure composed of the screen frame 100, the bottom plate 9 and the reinforcing stays 10a and 10b, and therefore the strength of the cabinet does not become insufficient even when the back cover 400 is not provided. Therefore, the back cover 400 is only needed to perform a function as a design cover. Thus, the back cover 400 can be thinner, so as to accomplish the reduction in weight and cost. Further, since the back cover 400 does not necessarily has a function of reinforcement, the back cover 400 can have a free form, and therefore the degree of freedom increases. Further, the screen frame 100 can be formed by molding the aluminum extruded material or the like so as to compose the design of the screen frame 100. In such a case, the number of design parts can be reduced, and therefore the cost can be reduced.

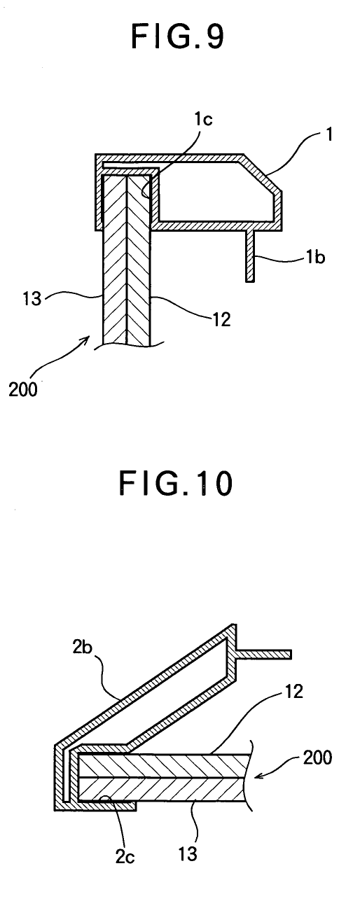

FIG. 8 is a front view showing a state where the screen 200 is mounted to the cabinet according to this embodiment. FIGS. 9, 10, 11 and 12 are respectively an A-A sectional view, a B-B sectional view, a C-C sectional view and a D-D sectional view of the cabinet shown in FIG. 8. The screen frame 100 is formed of aluminum extruded material as described above, and has a sectional shape required for functioning to hold the respective end portions of the screen and required for ensuring the rigidity, as shown in FIGS. 9 through 12.

As shown in FIG. 9, the upper-side frame 1 includes a groove 1c of a rectangular C-shape into which the upper part of the screen 200 (the Fresnel screen 12 and the lenticular screen 13) fits. Further, the length of the upper-side frame 1 in the depth direction is so determined as to ensure the strength for maintaining the angle of the screen frame 100 and the reinforcing frames 10a and 10b at a certain angle. Further, a mounting portion 1b is formed to protrude downward from the upper-side frame 1, and the upper end portions of the reinforcing stays 10a and 10b are fixed to the mounting portion 1b.

As shown in FIG. 10, the side frame 2b includes a groove 2c of a rectangular C-shape into which the side end portion of the screen 200 fits. The side frame 2b further extends in the direction inclined with respect to the normal line of the screen 200 so as to ensure the light path of the light incident on the screen 200. Further, although omitted in FIG. 10, the other side frame 2a and the side frame 2b are configured in a bilaterally-symmetrical manner.

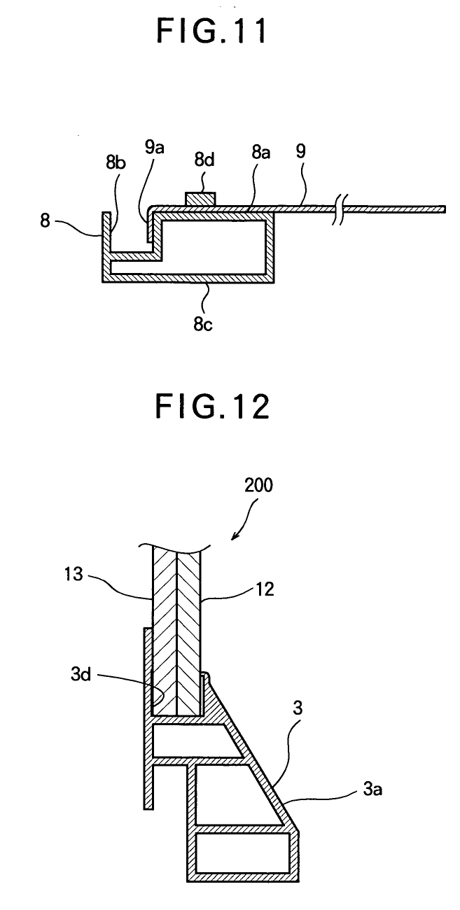

As shown in FIG. 11, the bottom frame 8 has a horizontal surface 8a to which the bottom plate 9 is fixed by means of screws 8d. A groove 8b is formed in the vicinity of the front end of the horizontal surface 8a. A front end portion 9a of the bottom plate 9 fixed to the horizontal surface 8a of the bottom frame 8 is bent into the inside of the groove 8b. The bottom frame 8 further includes a ground surface (a bottom surface) 8c having a sufficient area for receiving the weight of the cabinet together (with the above described insulators 14a and 14b).

As shown in FIG. 12, the lower-side frame 3 has a groove 3d of the rectangular C-shape to which the lower end portion of the screen 200 fits. The surface of the lower-side frame 3 on the right side of the groove 3d in the figure (i.e., the incident side of the screen 200) is formed as an inclined surface 3a for ensuring the light path of the light incident on the screen 200.

In this way, the screen frame 100 also has a function to hold the respective end portions of the screen 200, and therefore the number of parts can be reduced, so that the reduction in cost and weight can be accomplished.

As described above, according to this embodiment, due to the provision of the screen frame 100 holding four sides of the screen 200, the bottom plate 9 whose front end portion is fixed to the screen frame 100 and the reinforcing stays 10a and 10b connecting the upper-side frame 1 of the screen frame 100 and the rear end portion of the bottom plate 9, it becomes possible to maintain the angle between the screen frame 100 and the bottom plate 9 at a right angle. Therefore, it becomes possible to prevent the change in the angle between the screen 200 held by the screen frame 100 and the optical engine 300 mounted to the bottom plate 9. Further, since the rigidity of the cabinet is high, the relative positional relationship between the screen 200 and the optical engine 300 is not changed by the influence of the vibration during transportation or due to the influence of the installation location, and therefore it becomes possible to prevent the distortion and displacement of the image.

Particularly, in the rear projector having the wide-angle optical engine 300 as shown in FIG. 1, the incident angles of the light rays 18a through 18c on the screen 200 are very large, and therefore the position of the image projected on the screen 200 largely changes even when the screen 200 is slightly inclined with respect to the optical engine 300. However, according to this embodiment, the mounting positions and angles of the respective optical components can be correctly determined, and the influence of the vibration during transportation and the influence of the installation location can be eliminated, with the result that the distortion and displacement of the image can be prevented, and an excellent image can be displayed. Further, the reinforcing stays 10a and 10b are disposed obliquely along the contour of the light ray 18a so as to reduce the depth of the cabinet, and therefore the rear projector does not need an extra space, and can be installed at a location which is narrow in depth. Furthermore, due to the cabinet structure of a vertically-elongated rectangular triangle as seen from the side, it becomes possible to employ the back cover 400 having a characteristic shape that becomes narrower in the upward direction, and the design differentiation can be accomplished.

In this regard, although the bottom plate 9 is composed of sheet-metal in this embodiment, it is also possible that the bottom plate 9 is made of aluminum die-cast. In this case, the rigidity of the cabinet is further increased. In addition, although the reinforcing stays 10a and 10b are composed of sheet-metal in this embodiment, it is also possible that straight sections of the reinforcing stays are composed of square pipes of aluminum. In this case, the connecting portion between the upper frame 1 and the bottom plate 9 can be composed of sheet-metal or die-cast.

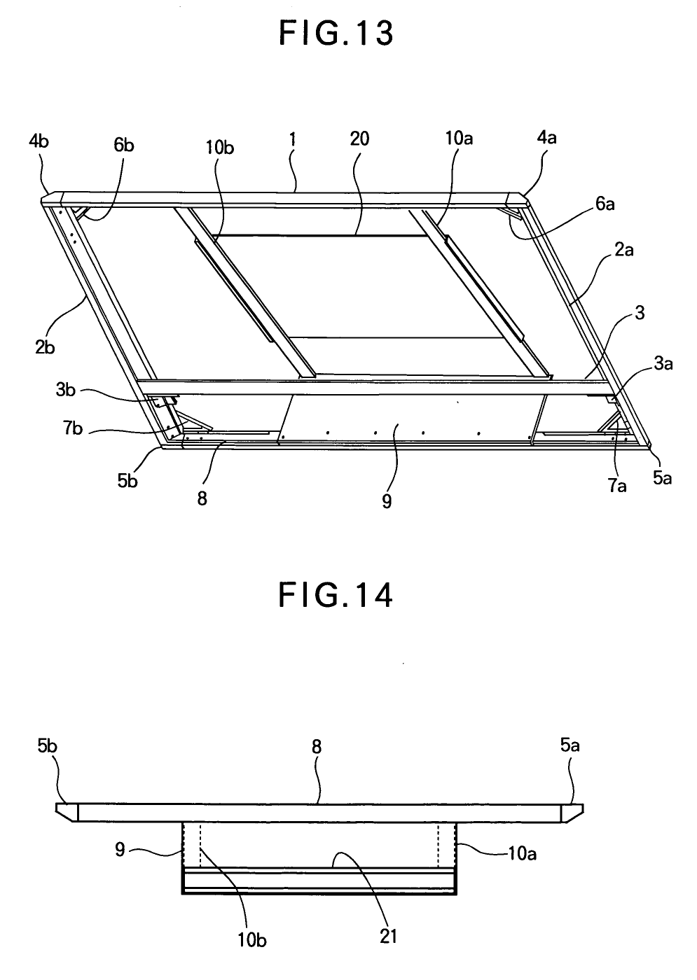

FIG. 13 is a perspective view showing another configuration example of the screen frame 100 according to this embodiment. In the configuration example shown in FIG. 13, a reinforcing plate (a connecting body) 20 is mounted between the reinforcing stays 10a and 10b. By mounting the planarly-extending reinforcing plate 20 between the reinforcing stays 10a and 10b, it is further ensured to prevent the deformation of the reinforcing stays 10a and 10b. As a result, the rigidity of the cabinet is further enhanced. Particularly, the effect of enhancing the rigidity against the external force applied from the side or the external force for distorting the cabinet is high. In this regard, although the reinforcing plate 20 is one wide plate in FIG. 13, the same advantage can be obtained even when two or more narrow plates are provided between the reinforcing stays 10a and 10b.

FIG. 14 is a bottom view showing a still another configuration example of the screen frame 100 according to this embodiment. In the configuration example shown in FIG. 14, a long leg portion 21 composed of sheet-metal and elongated in the lateral direction is mounted to the bottom plate 9 and on the back side with respect to the mounting positions of the reinforcing stays 10a and 10b. With such a configuration, the loads applied to the reinforcing stays 10a and 10b are entirely received by the leg portion 21, and therefore the deformation of the bottom plate 9 can be prevented. In this regard, in the case where the bottom plate 9 is formed of die-cast, it is also possible to preliminarily form protrusion(s) on the back side of the bottom plate 9, which replaces the insulators 14a and 14b (FIG. 5) and the leg portion 21 (FIG. 14).

### Embodiment 2

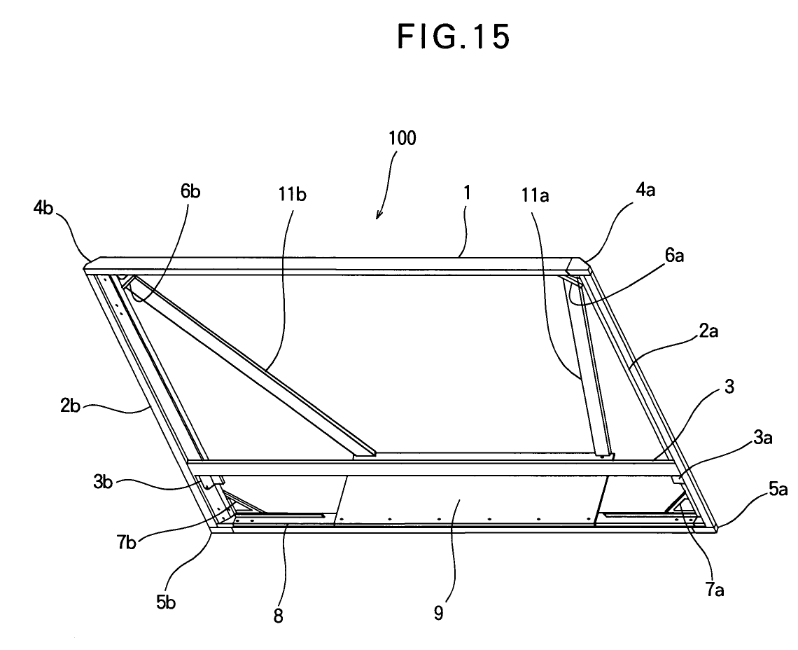

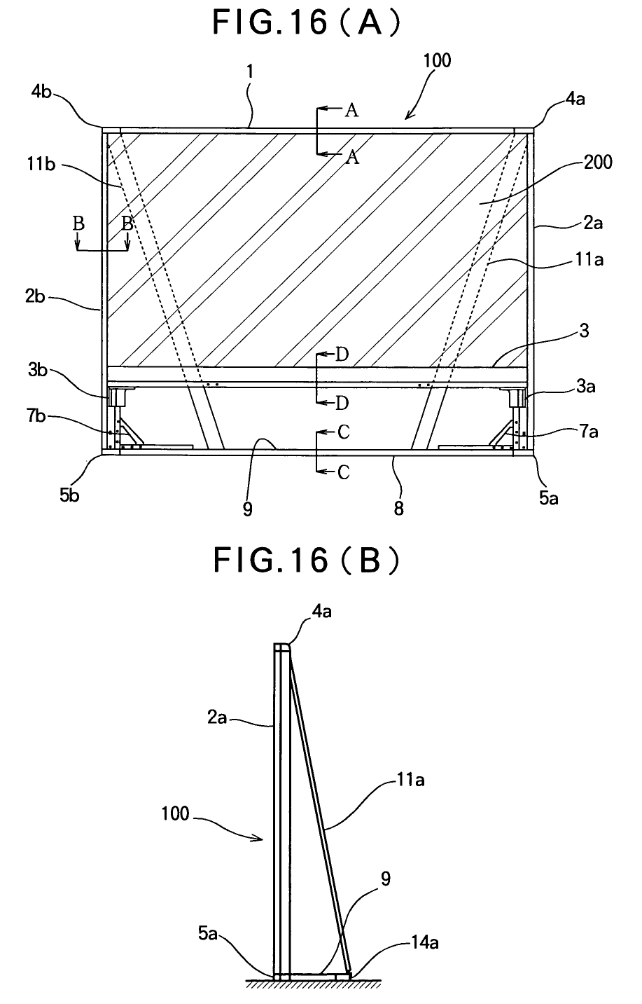

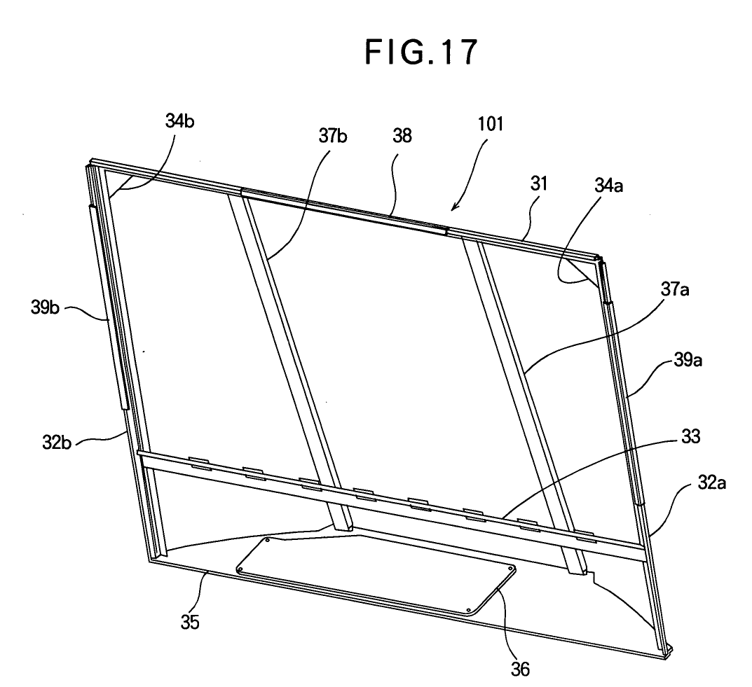

FIG. 15 is a perspective view showing a cabinet according to Embodiment 2 of the present invention. FIGS. 16(A) and 16(B) are a front view and a side view showing the cabinet according to Embodiment 2 of the present invention. In FIGS. 15 and 16, components which are the same as those described in Embodiment 1 are assigned the same reference numerals.

In the above described Embodiment 1, the reinforcing stays 10a and 10b (FIG. 4) are disposed parallel to each other. In contrast, in this embodiment, the interval between the reinforcing stays 11a and 11b becomes narrower in the downward direction. In other words, reinforcing stays 11a and 11b are mounted in such a manner that the interval therebetween is narrower at a position where the reinforcing stays 11a and 11b are mounted to the bottom plate 9 than at a position where the reinforcing stays 11a and 11b are mounted to the upper-side frame 1.

As shown in FIG. 15, an end portion of the reinforcing stay 11a is fixed to a corner plate 6a between the upper-side frame 1 and the side frame 2a, and the other end portion of the reinforcing stay 11a is fixed to the rear end portion of the bottom plate 9. An end portion of the reinforcing stay 11b is fixed to a corner plate 6b between the upper-side frame 1 and the side frame 2b, and the other end portion of the reinforcing stay 11b is fixed to the rear end portion of the bottom plate 9. The other configuration is the same as Embodiment 1.

In the above described Embodiment 1, the reinforcing stays 10a and 10b extend parallel to the side frames 2a and 2b as seen from the front of the cabinet (see FIG. 8). In contrast, in this embodiment, as shown in FIG. 16(A), the reinforcing stays 11a and 11b extend obliquely with respect to the side frames 2a and 2b as seen from the front of the cabinet. With this, even when the cabinet is applied with the force for distorting the cabinet, i.e., for example, even when the cabinet is applied with the force for changing the right angle between the side frames 2a and 2b and the upper-side frame 1, the deformation of the cabinet can be prevented by the bracing the reinforcing stays 11a and 11b.

Further, the reinforcing stays 11a and 11b are fixed to the corner plates 6a and 6b without removing the corner plates 6a and 6b of the screen frame 100, and therefore the rigidity of the entire body of the cabinet can be enhanced without reducing the rigidity of the screen frame 100.

Further, as shown in FIG. 16(B), the screen frame 100, the bottom plate 9 and the reinforcing stays 11a and 11b constitute a rectangular triangle whose base is the bottom plate 9. Therefore, as in Embodiment 1, the screen frame 100 and the bottom plate 9 are kept at a right angle, and the rigidity of the entire cabinet is enhanced, with the result that the distortion or displacement of the image can be prevented.

In the example shown in FIGS. 15 and 16, respective one end portions of the reinforcing stays 11a and 11b are fixed to the corners between the upper-side frame 1 and the side frames 2a and 2b (the corner plates 6a and 6b). However, it is also possible that respective one end portions of the reinforcing stays 11a and 11b are fixed to the upper-side frame 1, as long as the interval between the reinforcing stays 11a and 11b becomes narrower toward the bottom plate 9. Further, the rigidity of the cabinet can be further enhanced by further providing a reinforcing stay connecting the center of the upper-side frame 1 and the rear end portion of the bottom plate 9.

### Embodiment 3

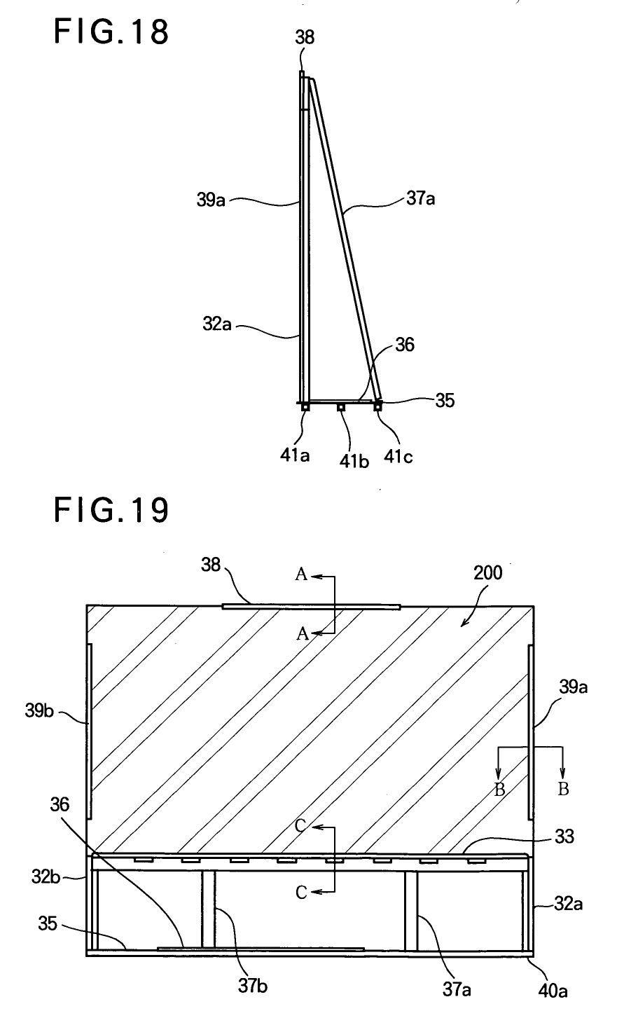

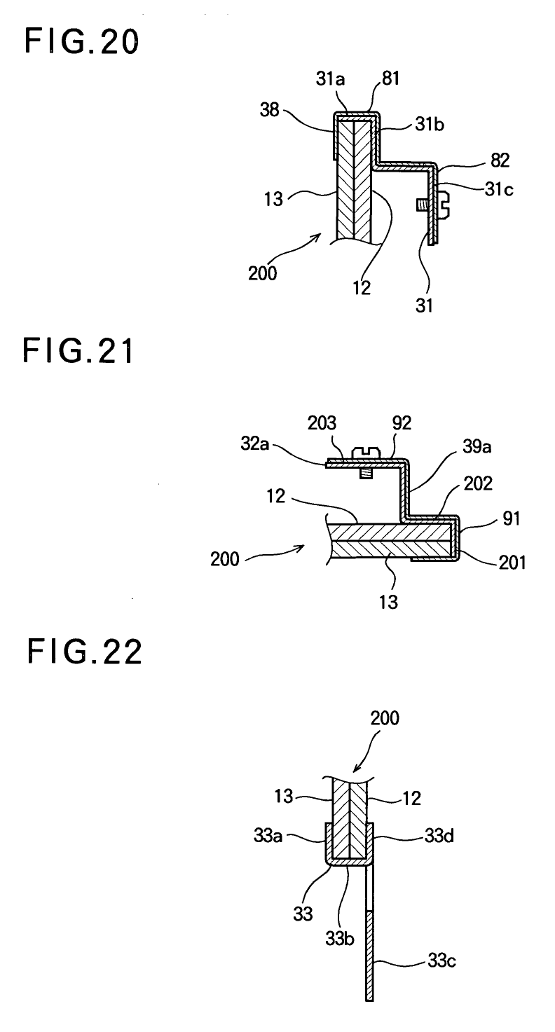

FIG. 17 is a perspective view showing a cabinet according to Embodiment 3 of the present invention. FIGS. 18 and 19 are a side view and a front view showing the cabinet according to Embodiment 3. FIGS. 20, 21 and 22 are respectively an A-A sectional view, a B-B sectional view, and a C-C sectional view of the cabinet shown in FIG. 19. In FIGS. 17 through 22, components that are the same as those described in Embodiment 1 are assigned the same reference numerals.

In the above described Embodiment 1, the screen frame 100 is formed of aluminum extruded material. In contrast, in Embodiment 3, the screen frame 101 is formed of sheet-metal. The screen frame 101 includes an upper-side frame 31 and a lower-side frame 33 that hold an upper side and a lower side of the screen 200 and side frames 32a and 32b that hold both lateral sides of the screen 200. In this regard, the bottom frame 8 (FIG. 4 or the like) described in Embodiment 1 is not provided.

A bottom plate 35 is fixed to the lower end portions of the side frame 32a and 32b of the screen frame 101 so that the bottom plate 35 is vertical with respect to the screen frame 101. Reinforcing stays 37a and 37b are provided to connect the upper-side frame 31 and the rear end portion of the bottom plate 35. As in Embodiment 1, the screen frame 101, the bottom plate 35 and the reinforcing stays 37a and 37b constitute a rectangular triangle whose base is the bottom plate 35 as seen from the side. With this, the angle between the bottom plate 35 and the screen frame 101 is kept at a right angle so as to ensure the rigidity of the cabinet (in particular, the rigidity in the front-rear direction).

A holding member 38 is mounted to the center of the upper-side frame 31, for holding the upper end portion of the screen 200 (FIG. 1). Holding members 39a and 39b are provided on the respective center portions of the side frames 32a and 32b, and respectively hold the lateral end portions the screen 200 (FIG. 1). A corner plate 34a is provided between the upper-side frame 31 and the side frame 32a. The corner plate 34a connects the upper-side frame 31 and the side frame 32a by means of screws. A corner plate 34b is provided between the upper-side frame 31 and the side frame 32b. The corner plate 34b connects the upper-side frame 31 and the side frame 32b by means of screws.

An upper plate 36 is fixed to a substantially center portion of the bottom plate 35 by means of screws. The upper plate 36 has a function as a base for mounting the optical engine 300 (FIG. 1) and a function to reinforce the bottom plate 35. Further, as shown in FIG. 18, three rectangular pipes 41a, 41b and 41c elongated in the lateral direction of the cabinet are mounted to the bottom of the bottom plate 35. The rectangular pipes 41a, 41b and 41c are respectively disposed on the front end portion, the center portion and the rear end portion of the bottom plate 35. The rectangular pipes 41a, 41b and 41c have functions as legs of the cabinet and functions to reinforce the bottom plate 35.

FIG. 19 is a front view showing a cabinet in a state where the screen 200 is mounted to the cabinet. The screen 200 is mounted to the upper-side frame 31, the side frames 32a and 32b and the lower-side frame 33 using holding members 38, 39a and 39b. As shown in FIG. 20, the upper frame 31 includes a contact wall 31a contacting the upper end surface of the screen 200, a contact wall 31b formed continuously with the contact wall 31a and contacting the surface of the incident side of the screen 200, and a rear wall 31c formed to recede rearward from the contact wall 31b. The holding member 38 has a rectangular C-shaped grip portion 81 that holds the upper end portion of the screen 200 by sandwiching the same from the outside of the contact walls 31a and 31b, and a fixing portion 82 formed integrally with the grip portion 81 and fixed to the rear wall 31c by means of screws.

As shown in FIG. 21, the side frame 32a includes a contact wall 201 contacting the lateral end surface of the screen 200, a contact wall 202 formed continuously with the contact wall 201 and contacting the surface of the incident side of the screen 200, and a rear wall 203 formed to recede rearward from the contact wall 202. The holding member 39a has a rectangular C-shaped grip portion 91 that holds the lateral end portion of the screen 200 by sandwiching the same from the outside of the contact walls 201 and 202, and a fixing portion 92 formed integrally with the grip portion 91 and fixed to the rear wall 203 by means of screws. The holding member 39b mounted to the side frame 32b and the holding member 39a are configured in a bilaterally symmetrical manner.

As shown in FIG. 22, the lower-side frame 33 is configured by bending a plate-like sheet-metal, and includes a contact wall 33a contacting the surface of the incident side of the screen 200, a contact wall 33b formed continuously with the contact wall 33a and contacting the lower end surface of the screen 200, and an extending wall 33c extending downward from the rear end of the contact wall 33b. Further, a contact wall 33d is formed by cutting and bending a part of the extending wall 33c so that the contact wall 33d faces the contact wall 33a, and the contact wall 33d contacts the surface of the incident side of the screen 200. The contact walls 33a, 33b and 33c of the lower-side frame 33 hold the lower end portion of the screen 200.

When the screen 200 is mounted to the screen frame 101, the lower end portion of the screen 200 is brought into engagement with the groove composed of the contact walls 33a, 33b and 33d (FIG. 22) of the lower-side frame 33. Then, the upper end portion of the screen 200 is brought into contact with the contact wall 31b (FIG. 20) of the upper-side frame 31, and both lateral end portions of the screen 200 are brought into contact with the respective contact walls 202 (FIG. 21) of the side frames 32a and 32b from the front. Then, the holding member 38 is mounted to the upper-side frame 31, and the holding members 39a and 39b are mounted to the side frames 32a and 32b, so that the upper end portion of the screen 200 is held by the holding member 38 and the both lateral end portions of the screen 200 are held by the holding members 39a and 39b.

In this regard, in order to mount the lower end portions of the side frames 32a and 32b of the screen frame 101 to the bottom plate 35, it is also possible to form holes into which the lower end portions of the side frames 32a and 32b fit, or to mount bracing struts on the bottom plate 35 for fixing the side frames 32a and 32b by means of screws. Further, if the lower end portions of the side frames 32a and 32b are welded to the bottom plate 35, a stronger fixing is enabled.

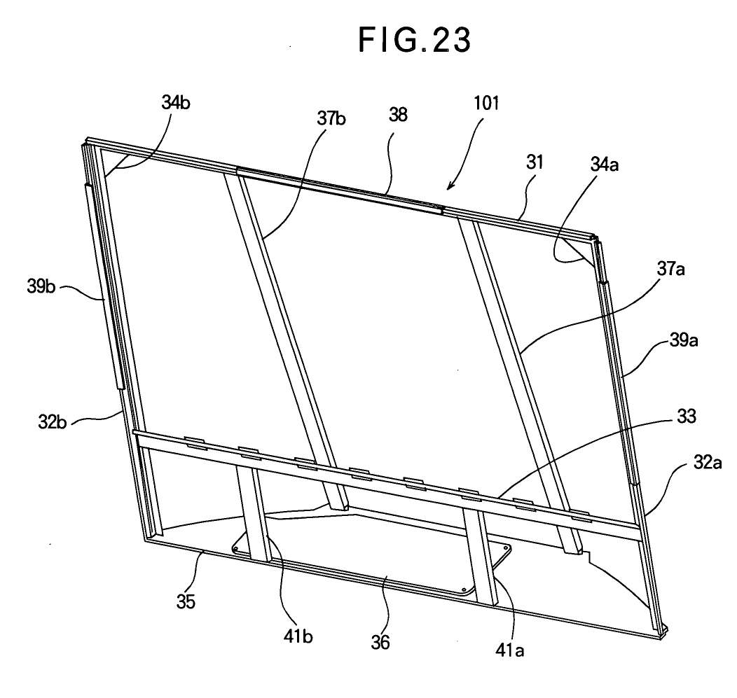

Further, in order to surely prevent the deflection of the lower-side frame 33 due to the weight of the screen 200, it is also possible to form the lower-side frame 33 of stainless steel, or to provide bracing struts 41a and 41b in substantially vertical direction between the lower-side frame 33 and the bottom plate 35 as shown in FIG. 23. Further, in this embodiment, the reinforcing stays 37a and 37b can be mounted in such a manner that the interval therebetween becomes narrower in the downward direction as was described in Embodiment 2.

As described above, according to this embodiment, the screen frame 101 is made of sheet-metal, and therefore the screen frame 101 of various shapes can be easily manufactured. Therefore, the screen frame is easily made responsive to the change of design, and is also suitable for trial production or small-lot production. Further, since the screen 200 is mounted to the screen frame 101 from the front, the assembling can be easy, and a replacement of the screen 200 can be easily performed.

### Embodiment 4

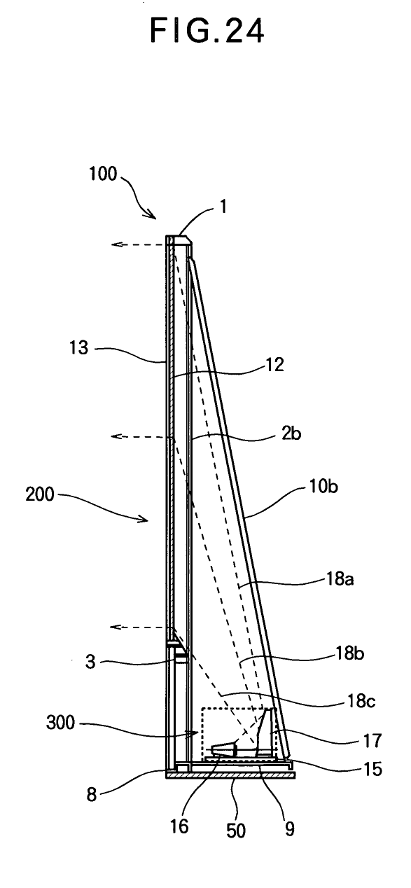

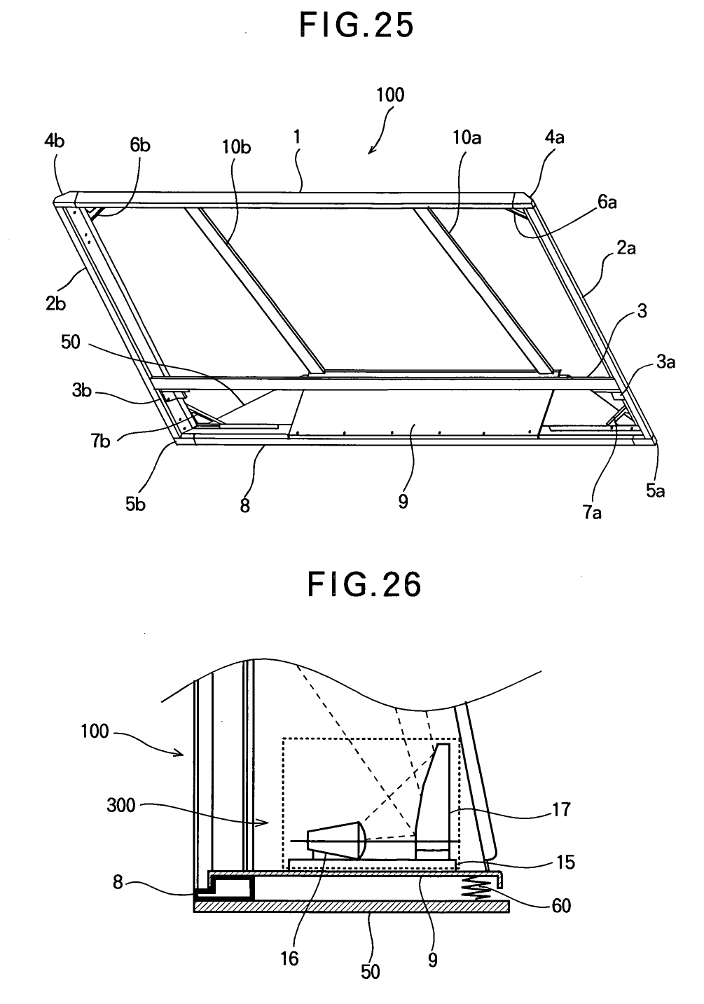

FIG. 24 is a sectional view showing a rear projector (a projection apparatus) provided with a cabinet according to Embodiment 4 of the present invention. FIG. 25 is a perspective view showing the cabinet according to Embodiment 4. FIG. 26 is an enlarged view showing a part of the rear projector according to the modification of this embodiment. In FIGS. 24 through 26, components that are the same as those described in Embodiment 1 are assigned the same reference numerals.

In the above described Embodiment 1, the bottom plate 9 supports the cabinet using the insulator 14a and 14b (FIG. 5). In contrast, in this embodiment, a cabinet base 50 connected to the lower end of the screen frame 100 is configured to support the entire body of the cabinet. The cabinet base 50 is connected to the bottom surface of the bottom frame 8 of the screen frame 100, and supports the entire body of the cabinet by being connected to the screen frame 100. In this embodiment, although the insulators described in Embodiment 1 are not provided in specific examples shown in FIGS. 24 and 25, it is also possible to provide such insulators on the bottom surface of the cabinet base 50.

Further, the bottom plate 9 holding the optical engine 300 does not directly contact the cabinet base 50. The front end portion of the bottom plate 9 is fixed to the bottom frame 8, and the rear end portion of the bottom plate 9 is connected to the upper-side frame 1 via the reinforcing stays 10a and 10b, so that the bottom plate 9 is supported in a manner of being suspended by the screen frame 100.

According to this embodiment, as in Embodiment 1, the screen frame 100, the bottom plate 9 and the reinforcing stays 10a and 10b. constitute a rectangular triangle whose base is the bottom plate 9, and therefore the angle between the screen frame 100 and the bottom plate 9 is a right angle, and the angle of the optical engine 300 with respect to the screen 200 can be correctly determined.

Further, in this embodiment, the bottom plate 9 is held in a manner of being floated from the cabinet base 50, and therefore, even when the external force is applied to the screen frame 100 or even when the screen frame 100 is inclined due to the influence of the installation location, the bottom plate 9 and the reinforcing stays 10a and 10b are not directly applied with the force. Therefore, the shape of the rectangular triangle composed of the screen frame 100, the bottom plate 9 and the reinforcing stays 10a and 10b does not change, with the result that the angular relationship between the screen 200 and the optical engine 300 is held constant. Therefore, the image projected on the screen 200 is not distorted or displaced, with the result that an excellent image can be consistently displayed.

In the modification shown in FIG. 26, a cushion member such as a spring 60 is inserted between the bottom plate 9 (supporting the optical engine 300) and the cabinet base 50. With such a structure, it is possible to restrict the swing of the cabinet due to the vibration during transportation and the inclination of the cabinet when the external force is applied to the screen frame 100. In this case, the spring 60 has a function to correct the rearward inclination of the cabinet due to the weights of the optical engine 300 and the electric parts (not shown) or the like. Further, in some applications, it is also possible to use a damper (not shown) instead of the spring 60, or to dispose both of the spring 60 and the damper in combination with each other.

1. A cabinet of a projection apparatus, said projection apparatus comprising a rectangular screen and an optical engine that projects an image onto a back surface of said screen from below,
said cabinet comprising:
a screen frame that holds four sides of said screen, said screen frame having at least an upper-side frame that supports an upper side of said screen;
a bottom plate that holds said optical engine, an end portion of said bottom plate being mounted to said screen frame, and
a reinforcing stay that connects said upper-side frame of said screen frame and the other end portion of said bottom plate along a contour of light ray projected onto said screen.

2. The cabinet of the projection apparatus according to claim 1, wherein an angle between said bottom plate and said screen is a right angle.

3. The cabinet of the projection apparatus according to claim 1, wherein at least two said reinforcing stays are provided.

4. The cabinet of the projection apparatus according to claim 3, further comprising a connecting body that connects said two reinforcing stays.

5. The cabinet of the projection apparatus according to claim 3, wherein said two reinforcing stays are mounted in such a manner that an interval between said reinforcing stays is narrower at a position where said reinforcing stays are mounted to said screen frame than at a position where said reinforcing stays are mounted to said bottom plate.

6. The cabinet of the projection apparatus according to claim 1, wherein a supporting member for supporting a load is disposed below a position of said bottom plate where said reinforcing stay is mounted.

7. The cabinet of the projection apparatus according to claim 1, wherein said screen frame includes a lower-side frame that supports a lower side of said screen, and a pair of side frames that respectively support both lateral sides of said screen, in addition to said upper-side frame.

8. The cabinet of the projection apparatus according to claim 7, wherein a reinforcing member is provided on a portion where said upper frame and said side frame are connected.

9. The cabinet of the projection apparatus according to claim 7, further comprising a bottom frame that connects lower end portions of said pair of side frames,
wherein said end portion of said bottom plate is mounted to said bottom plate.

10. The cabinet of the projection apparatus according to claim 7, where at least one bracing strut is provided between said lower-side frame and said bottom plate, said bracing strut supporting said lower-side frame.

11. The cabinet of the projection apparatus according to claim 1, wherein said screen frame is formed of extruded material.

12. The cabinet of the projection apparatus according to claim 1, wherein said screen frame is formed of sheet-metal.

13. The cabinet of the projection apparatus according to claim 1, further comprising a cabinet base connected to a lower end portion of said screen frame, said cabinet base supporting said screen frame without contacting said bottom plate.

14. The cabinet of the projection apparatus according to claim 13, wherein a cushion member is provided between said bottom plate and said cabinet base.

15. A projection apparatus comprising said cabinet of said projection apparatus according to claim 1, said screen, and said optical engine.
